(19) United States
(12) Patent Application Publication
(10) Pub. No.: US 2007/0061255 A1
(43) Pub. Date: Mar. 15, 2007

(54) Point of Sale Credit System

(76) Inventors: Thomas W. Epting, Greenville, SC (US); Richard E. Greer, Greenville, SC (US)

Correspondence Address: PHILIP H. BURRUS, IV, 460 Grant Street, Atlanta, GA, 30312, US

(21) Appl. No.: 11/531,189

(22) Filed: Sep. 12, 2006

Related U.S. Application Data
(60) Provisional application No. 60/716,109, filed on Sep. 12, 2005.

(51) Int. Cl. G06Q 40/00

(52) U.S. Cl. 705/39; 235/380

(57) ABSTRACT

A method and system for providing credit at a point of sale are provided. The method includes both an open-ended model and a closed-ended model. In the open-ended model a card, such as a credit card, is provided to the customer. The customer first enters into an agreement for repayment with a credit provider. When the customer uses the card, a new installment transaction is added to a revolving line of credit. An open-ended loan agreement is delivered to the customer at the point of sale. The open-ended loan agreement may include available credit left, payment terms, and payment date. In the closed-ended model, the customer need not first sign an agreement with the credit provider. The customer simply obtains and uses a card to obtain a closed-ended, single installment, installment loan.

### CROSS REFERENCE TO PRIOR APPLICATIONS

This application claims priority and benefit under 35 U.S.C. §119(e) from U.S. Provisional Application No. 60/716,109, filed Sep. 12, 2005, which is incorporated by reference for all purposes.

### BACKGROUND

1. Technical Field

This invention relates generally to a computer method and system for creation of individualized financial instruments, and more specifically to a method and system of providing financial cards at a point of sale, where a customer may activate the card and make purchases at the point of sale.

2. Background Art

Check cashing businesses have been established to advance funds to customers based upon post-dated checks written by the customer. Typically, the customer must avail himself to such businesses during normal business hours, and must also make their checks payable in relatively large increments, such as multiples of fifty dollars. Once the customer has made a deposit in his checking account, the check cashing business presents the check for payment. This business extracts a fee for the service, which may be cost prohibitive to some customers. Further, because the customer is provided with cash in relatively large increments, such as multiples of fifty dollars, the customer may actually be required to obtain more cash than their immediate needs require. The customer may then be tempted to use such excess cash on non-necessities, which may again contribute to a lack of funds after the next payday. This may then require the customer to go back to the check cashing business, resulting in an unfortunate financial cycle for the customer.

Another item of inconvenience is the fact that the customer must not only be present at such check casing business during that business's operating hours, but the customer must thereafter travel to an actual merchant location to purchase goods and services, such as medicine, groceries, merchandise, clothing, gasoline, utilities, and the like.

In the event the customer writes a check backed by less than sufficient funds, the customer generally will incur significant additional penalties and fees from their bank, in addition to those penalty fees associated with merchants and other parties to whom such checks are written.

There is thus a need for a method and system with which a customer may obtain credit and make purchases at a single point of sale.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of a system for extending point of sale credit in accordance with one embodiment of the invention.

FIG. 2A illustrates one embodiment of a method for offering point of sale credit in accordance with the invention.

FIG. 2B illustrates one embodiment of a method for receiving payment in accordance with the invention.

FIG. 2C

FIG. 3 illustrates one embodiment of a sample loan agreement between a customer and provider of credit in accordance with the invention.

FIG. 4 illustrates one example of a financial instrument generated in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to offer and approve credit at a point of sale. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of extending and approving credit at the point of sale as described herein. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and associated hardware with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Generally, the present invention provides a method and system for a provider of credit to extend credit to a customer by establishing an account to do so, with such account being paid off, or significantly paid down, on or after the customer's next payday. Payments may be withdrawn by the provider of credit electronically directly from the customer's bank account.

A merchant system as set forth herein is used to read or recognize a unique customer identifier device, such as a magnetically encoded or bar-coded customer card. In one embodiment, the customer identifier device comprises a preloaded credit card. Such a card may look on the surface like an ordinary credit card, with a bank or brand named identifying the card as such imprinted thereon. The card may have associated therewith, however, a preloaded spending limit. For example, each card may have a limit of $50 or less with which the customer may make purchases.

Such cards are offered at retail locations. For example a provider of credit may make a plurality of cards available at a point of sale location, such as a checkout counter or cash register location. When the customer wishes to obtain a card and charge an item to the account associated with the card, the customer first selects the card and presents the card to the merchant system. The merchant system then reads an account number associated with the preloaded credit card. The merchant system may also obtain other information, including checking account information, perhaps from a voided blank check, and identification information such as a driver's license number belonging to the customer. The merchant system then sends such information to a server system affiliated with the provider of credit. In one embodiment, referred to herein as the “open-ended model”, the information is sent along with a request that the server system access databases containing information about the customer, such as the customer's name, social security number, payment plan, credit limit, amount of credit available, current amount of credit outstanding, payment dates, and the like. Other databases may be required or used by the merchant system in accordance with government regulations. The server system in the open model then uses the customer information to issue an approval or disapproval back to the merchant system.

In another embodiment, only an account number associated with the preloaded credit card and the identification information is sent. In this embodiment, referred to herein as the “closed-ended model” the merchant system need not validate loan and personal information. To the contrary, the merchant system in the closed-ended system instantly makes available a preloaded spending limit, such as twenty-five dollars, available to the customer. The provider of credit assumes the risk of non-repayment by the customer. The provider of credit transmits a closed-end, single installment, installment loan document to the customer at a later date. Once repayment is made, the provider of credit replenishes the preloaded spending limit.

Where the purchase transaction is approved, in the open-ended system, the server system may calculate and transmit to the merchant system applicable federal and state “Truth in Lending” disclosure information including finance charges, amount financed, transaction fee, total payments, payment schedule, and the annual percentage rate (APR). In the closed-ended system, such information may be printed on packaging associated with the card. The server system may additionally calculate a variable annual percentage rate based upon the date of the transaction and the date of payment.

In the open-ended system, the server system may further determine the payment schedule for the customer, to which the customer would have already agreed via a contract entered into at an earlier date between the customer and provider of credit. Such an agreement may be incorporated into a new credit sale. Such an agreement addresses and discloses transaction fees imposed by the provider of credit on a per transaction basis. It is to be understood, however, that instead of, or in addition to, the transaction fee, interest charges could be imposed on the customer based upon the amount of transaction. The server system may determine the actual calendar dates on which payment is to be made by the customer, as well as the actual payment method. For example, payment methods may include electronic funds transfer, automated check clearing house transactions, cash, checks, or other means. In the closed-ended system, such a contract is sent after the customer has already completed the transaction with the preloaded credit card.

The server system converts and formats a transaction document, i.e. a financial instrument, which is ultimately printed by the merchant system. In the open-ended system, the financial instrument adds an additional installment and repayment authorization to a continuing line of credit. In the closed-ended system, the financial instrument comprises a closed-ended, single installment, installment loan document. Using the information discussed above, such a financial instrument is created, printed out, and ultimately signed by the customer at the point of sale.

The server system communicates with the merchant system to generate the financial instrument which, in one embodiment, is printed at the actual merchant point of sale. Such a location may include a checkout stand or cash register location. Such a financial instrument may even be printed by the same printer used to print merchandise receipts.

Through cooperation of the merchant system and the server system, the financial instruments created are purchase transaction initiated and are stand alone documents ready for the customer's signature at the point of sale for the amount of the transaction, together with any terms and conditions of transaction fees. Such financial instruments may be configured to be in compliance with applicable federal state, and local requirements for such transactions.

It is well to note that the merchant system and server system may be located on the same premises, or could be separated with communications between the two being handled by a network. Further, it will be clear to one of ordinary skill in the art having the benefit of this disclosure that the merchant and provider of credit may be the same or different parties.

The present invention includes a server system configured to produce the financial instrument and to deliver it to the customer for each transaction, either in the open-end or closed- end format, depending upon the card type, agreement between customer and merchant, and particular circumstances. Statements may additionally be furnished to the customer on a periodic basis, such as monthly, quarterly, or annually. Further, the server system may be configured to provide a closed-ended financial instrument for a certain number of transactions, and then an open-ended financial instrument going forward. For example, a customer may obtain a preloaded credit card by way of the closed-ended system, and may then be converted to the open-ended model after a predetermined number of successful repayment cycles. The present invention also contemplates using the server system equipment for both merchant credit sales and for providing a cash loan to a customer, using the same or a modified database.

Additionally, the present invention includes the use of a customer's check, debit card, credit card, etc. and the presentation by the customer of the same in order to form a credit agreement. By way of example, in one embodiment the customer provides the merchant with a blank, voided check having account indicia disposed thereon. With a blank, voided check, the merchant is able to “swipe” the card through a check reader to obtain the checking account number from the MICR line. Using only such check, debit card, credit cad, etc. presented to a merchant, the merchant can create a closed-end merchant consumer credit sale generally in compliance with applicable federal, state, and local law and regulations.

In one embodiment of the invention, credit underwriting for a financial transaction is automatically commenced and concluded by the initiative of a customer. The customer initiates the financial transaction by interfacing with a merchant application. This interface may include a point of sale terminal, a card reader, a kiosk or the like. Customer-pertinent information and financial transaction pertinent information is obtained as a result of the customer initiating the process. The customer may also deliver the customer-pertinent information to a clerk for submission to the provider of credit through a cash register or credit card terminal.

In the open-ended system, the customer-pertinent and financial transaction pertinent information is then processed and the credit underwriting is approved if the customer associated with the customer-pertinent information is qualified for underwriting of a transaction described by the financial transaction pertinent information. A financial agreement that can be accepted by the customer interfacing to the merchant application is then generated and, if accepted by the customer, the funding for the financial transaction is provided. The processing of the information can include examining a database that includes customer data that correlates to the customer pertinent information and regulatory information required by the state in which the merchant operates, government imposed requirements and merchant imposed requirements.

In the closed-ended system, customer identification information and preloaded credit card information is submitted, and the card is instantly activated. Other customer information is then obtained at a later date.

Examining embodiments of the invention in more detail, a method and system for creation of unique purchase decision initiated financial instruments for point of sale transactions is provided. Such point of sale transactions could be carried out in wholesale contexts, retail contexts, e-commerce contexts, business-to-business contexts, and the like. Embodiments of the invention include a combination of computer hardware and software for allowing the creation of new, individualized financial instruments, including loan documents, at the point of sale. These financial instruments, which may be open-ended or closed-ended, may be used for the amount of the transaction or for a combination of transactions, or for establishment of new accounts and for issuing instant credit. The financial instruments often will be between a customer and a merchant. The merchant may be the provider of credit. Alternatively, the provider of credit may be a banks or other financial institution.

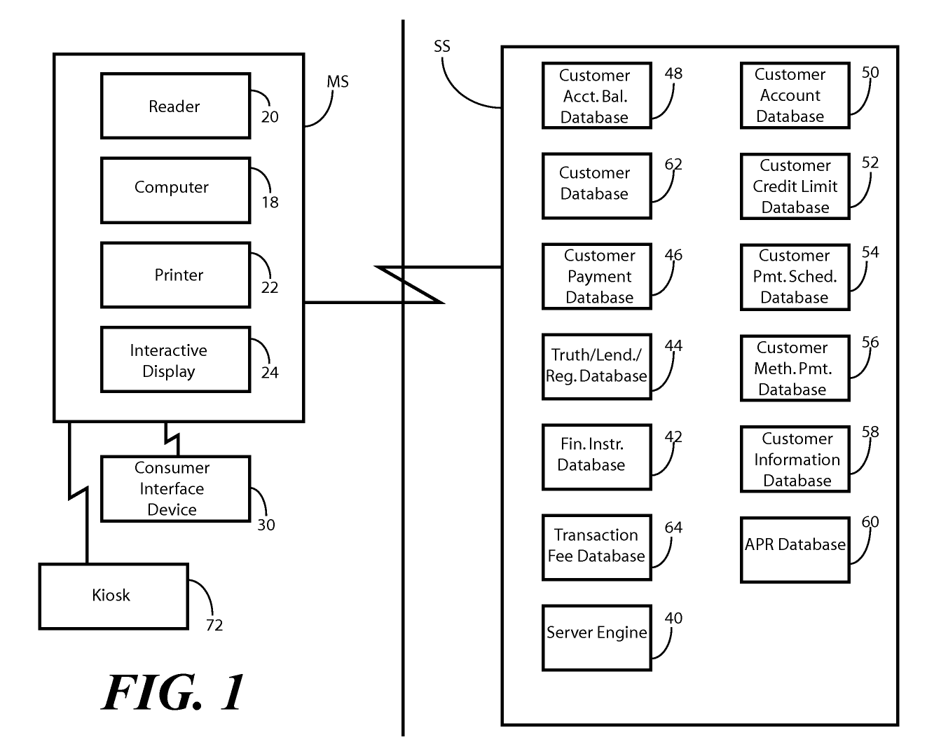

Turning now to FIG. 1, illustrated therein is a block diagram of one embodiment of the present invention. This embodiment includes a point of sale purchase transaction system having a merchant system and a server system. The merchant system, labeled generally “MS,” is computer-based, and also includes a reader 20, a printer 22, and an interactive display 24 interfaced with the computer 18. The reader 20 is used to read a customer interface device, such as a card, which can be encoded with magnetic, barcode, optical, etc. encoding, or could be a chip or microcomputer capable of storing identifying information about the customer. It is to be understood, however, that the customer interface device, or, referred to herein generally as a key, or, card 30, could be of various configurations, and, could be bypassed altogether by the customer, with the customer simply entering a personal identification number (PIN) together with a user ID, or through use of some other identification means, such as a driver's license number, together with an identification number. The information may also be given directly to a merchant's agent, such as a clerk or employee.

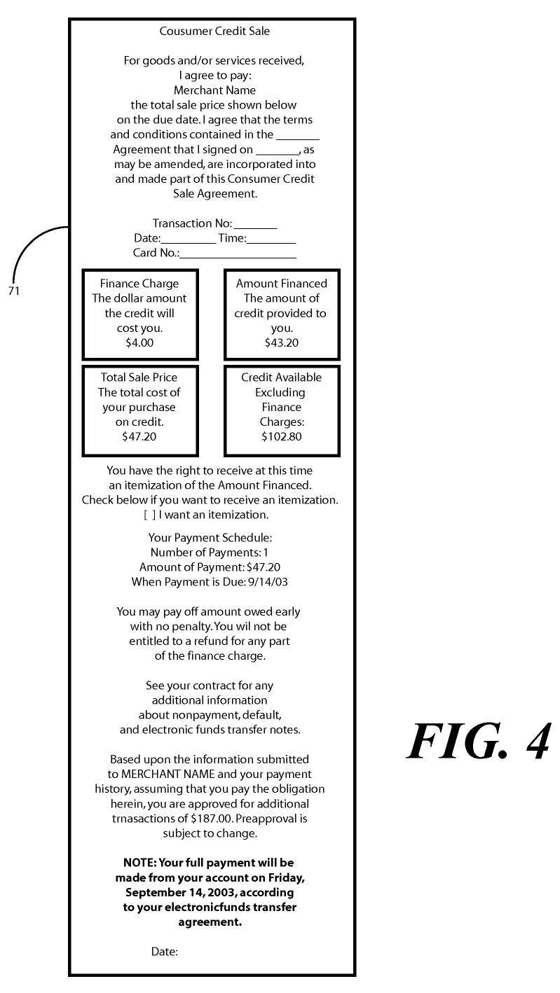

The reader 20 is preferably connected to the computer 18 and transmits information to the server system, shown generally as SS. The printer 22 or interactive display 24, which are connected to computer 18, could, instead, be connected directly to the server system SS, if desired, and serve to printout or display uniquely tailored financial instruments, an example of which is shown in FIG. 4, both for the merchant, and for the customer. It will be understood by those of ordinary skill in the art having the benefit of this disclosure that the financial instruments (with exemplary embodiments illustrated in FIG. 4) are representative only, and that the present invention is not limited to such examples. Further, the financial instruments could take on a variety of different configurations, appearances, and styles, without departing from the teachings of the disclosure. For example, while one financial instrument is directed to an open-ended, revolving credit line, another financial instrument is directed to a closed-end, single installment, installment loan.

As noted above, the merchant system MS and server system SS could be co-located on the same premises, or could be separated altogether in different locations. Communication is enabled between merchant system MS and server system SS, such as through the use of conventional telecommunications systems, local area networks, wide area networks, point-to pint dial-up connections, or through radio frequency systems, microwave systems, infrared systems, optical systems, satellite systems, the World Wide Web (WWW), etc. Merchant system MS and server system SS may each comprise any combination of hardware or software that allow interaction between the merchant system MS and the server system SS, and such software and hardware will be apparent to one of ordinary skill in the art.

Server system SS includes a server engine 40, a financial instrument creation and format database 42, a Truth In Lending and regulatory database 44, a customer payment plan database 46, a customer account balance database 48, a customer account database 50, a customer credit limit database 52, a customer payment schedule database 54, a customer method of payment database 56, a customer information database 58, having the customer's personal information, such as the customer's name, address, employer name, social security, and personal information, an annual percentage rate (APR) database 60, a customer database 62, and a transaction fee database 64. Some of these databases will not be required by some embodiments. For example, it may be unnecessary in the closed-ended model to access the customer account balance database 48, customer credit limit database 52, and the like to activate the preloaded credit card. It should also be understood that the term database might be applied to separate data bases created through programs such as MICROSOFT ACCESS or other similar products, or through proprietary programs or simply as indexed flat files. Thus, the databases may be physical databases or logical databases.

The server engine 40 receives requests from the merchant system MS and provides responses back to the merchant system MS. Requests from the merchant system MS would indicate that the customer is requesting a credit sale.

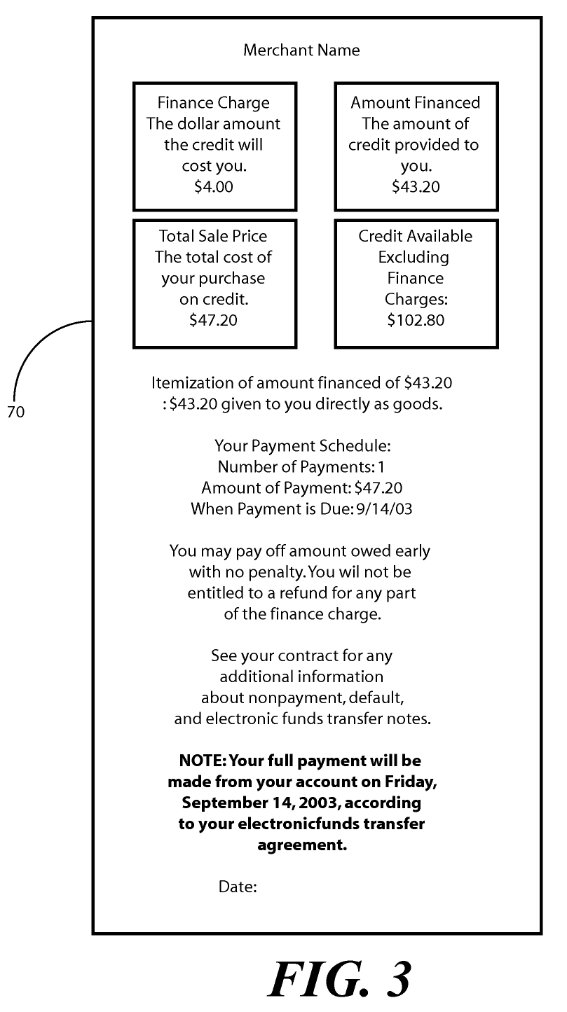

In the open-ended system, the customer database 62 contains customer information for various customers who have entered into an agreement with the merchant. An example financial instrument (70) for the open-ended system between a customer and a merchant is illustrated in FIG. 3, although it is to be understood that such agreement is illustrated for example purposes only, and that the agreement could be made between the customer and the merchant in a variety of different ways without departing from the teachings of this disclosure. For example, they could be simplified or made more elaborate in printed form, or could be provided to the customer in electronic form via email or at the point of sale, with the customer's signature being captured electronically and stored electronically.

In the closed-ended system, many of the terms found in the agreement may be printed on the packaging of the card itself. For example, in one embodiment, the cards are available at a point of sale, such as a checkout stand. To request a credit sale, the customer selects a card, and gives the card and at least one piece of identification information to the merchant. This identification information may include a driver's license number. To ensure that the customer understands the terms of the agreement, the merchant may ask the customer to acknowledge that he has completely read the terms and conditions on the packaging.

The customer method of payment database 56 contains information regarding the customer's agreed upon methods of payment, be it electronic funds transfer (EFT), automated check clearinghouse (ACH), payment by cash, check, debit card, credit card, or some other means. In the open-ended system, this payment database 56 is populated with such information upon the customer entering into an agreement with the provider of credit. In the closed-ended system, the information is not obtained until after the customer has used the preloaded credit card in a transaction.

The customer payment schedule database 54 includes information regarding the date on which the customer normally receives a deposit, such as his paycheck. The customer credit limit database 52 contains information regarding the credit limit or predetermined spending limit that has been assigned to a particular card or customer. The customer account balance database 48 contains information on the customer's then-current balance owed (or owed to the customer by the merchant, in the event the customer has a credit balance). The customer account database 50 contains information regarding the customer's account number, account status, such as active, inactive, closed, etc. The Truth in Lending and regulatory database 44 contains information regarding applicable truth in lending federal, state and local disclosure information regarding finance charges, amount financed, total payments, payment schedule, and annual percentage rate.

This database may also include other information required by individual jurisdictions for completion of financial documents and miscellaneous information that may be required by the merchant or government regulatory body. The transaction fee database 64 provides the appropriate transaction fee to be charged for the particular transaction.

The financial instrument creation and formatting database 42 contains information regarding the creation of financial instruments for execution by the customer in a point of sale transaction, and also for formatting the financial instrument 70 (examples of which are illustrated in FIG. 4) for printing out on a printer 22 for execution by the customer. As an alternative to printing the financial statement on paper, the financial instrument 70 may be presented in a graphical or digital form, which the customer would execute by signing a touch screen-type display. This could find particular use in automated and/or self-checkout stations used by some merchants. The format of the actual financial instrument format may be held in template form, physically or electronically, in the merchant system MS, server system SS, or terminal, or held in the printer 22 or interactive display 24.

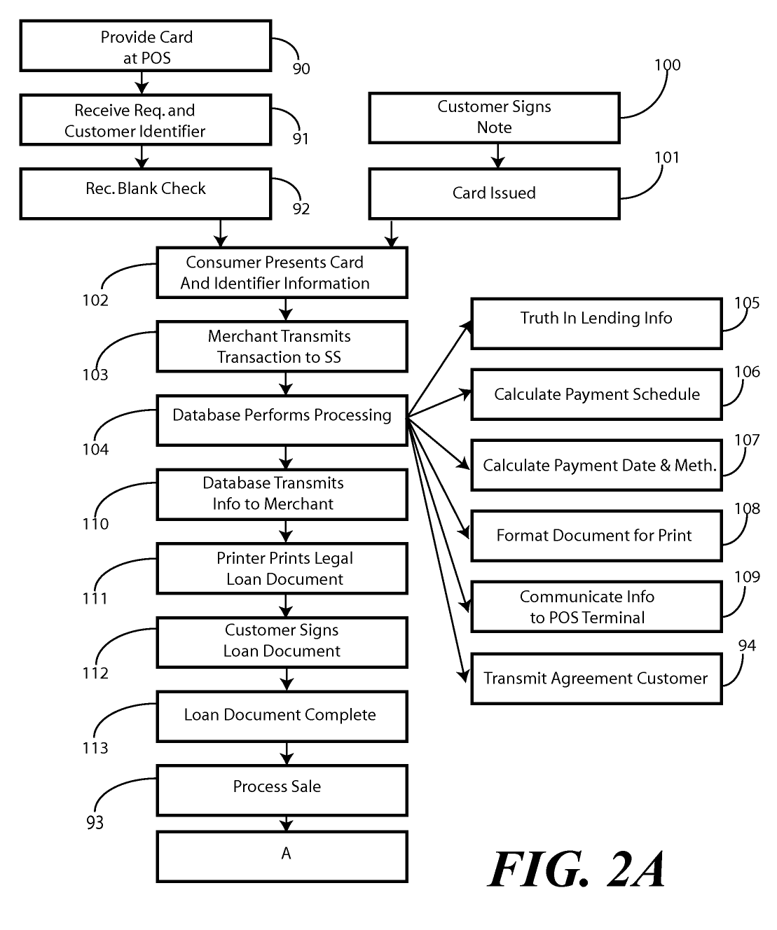

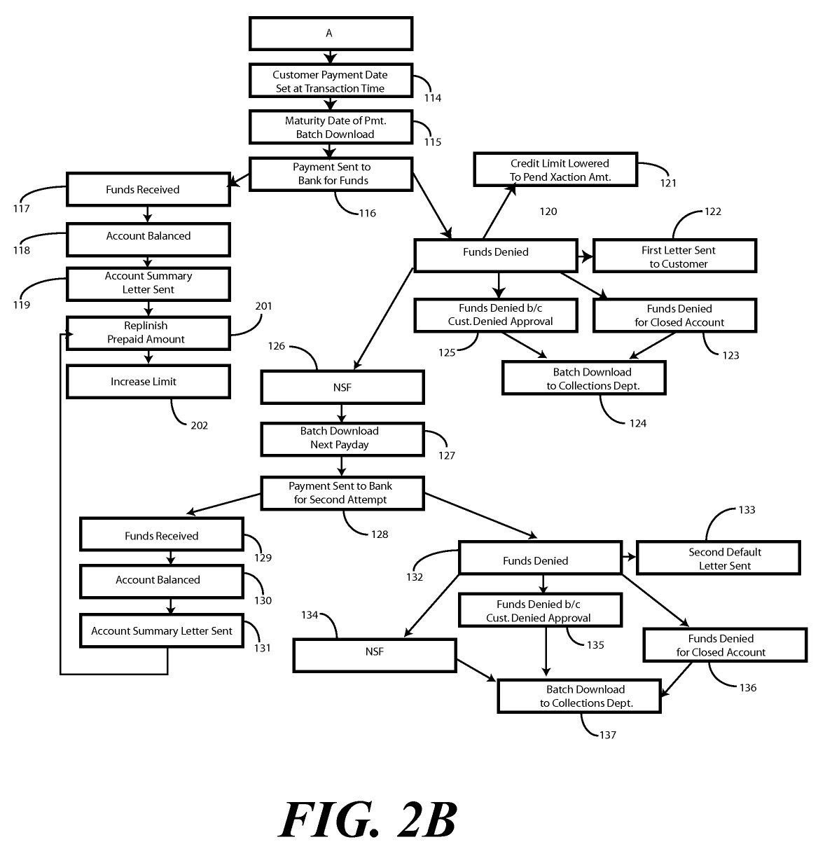

Turning now to FIGS. 2A and 2B, illustrated therein is one embodiment of a flow diagram for creating point of sale financial instruments in accordance with the present invention.

At the outset, to enable the server system (SS) to be operational for particular customer, the basic information will need to be input into the server system (SS) pertaining to the customer. This information can be keyed in by an operator, based on the information provided to the merchant, or its designee, by the customer on an financial instrument (70), such as illustrated in FIG. 3, or could be inputted into a computer directly by the customer at a website provided by the merchant, through use of the world wide web. Alternately, a merchant could provide a kiosk (72), or other data entry point, on-site for use by the customer to complete an application for a merchant credit account with the particular merchant.

At step 90, used in conjunction with the closed-ended model, a financial card, such as a preloaded credit card, is provided at the point of sale. Where the provider of credit and the merchant are different, this step may include the provider of credit providing at least one financial card having a financial card account number associated therewith to the point of sale merchant, and the point of sale merchant providing the financial card at the point of sale. Such financial cards may be packaged in a consumer accessible format, such as on a cardboard backing or wrapped in cellophane. The customer then selects the card for use.

The card may also be selected in such a fashion in the open-ended model. However, in the open-ended model, the customer completes an agreement at step 100, and a card may be issued then at step 101.

In step 102, the customer presents the card or other device for a transaction with the merchant. The merchant thus receives a request for use of the card at the point of sale at this step.

Prior to this step, for example in the closed-ended model where the customer has not necessarily entered into an agreement with the merchant or credit provider, the merchant may receive at least one piece of identification information at step 91. By way of example, the customer may provide a driver's license number as one form of identification information. Additionally, where bank account information is required, the customer may provide, and the merchant may receive, such information at step 92. For instance, the customer may present a blank, voided check with which the merchant system (MS) can read the account number from the MICR line.

The merchant transmits the transaction, which may include both a financial card identifier, such as an account number and the identification information, in step 103, to the server system (SS), and steps 104, 105, 106, 107, 108 and 109 involve use of software to process the information drawn from databases (42, 44, 46, 48, 50, 52, 54, 56, 58, 60, and 62) of the server system (SS), as required. The server system (SS), after processing such information, forwards a response, which may be in the form of an authorization acknowledgement, back to the merchant server (MS) in step 110. In the open-ended model, where a credit line is revolving, this authorization acknowledgement will indicate whether the present transaction is approved or disapproved.

In the closed-ended model, the authorization acknowledgement for the first transaction will indicate that the card has been approved. For subsequent transactions, the authorization acknowledgement will indicate whether the customer has sufficient funds with which to make the purchase. Where this is not the case, the present transaction may be disapproved. Additionally, where the card is being used for the first time, the card will be activated in the server system (SS) at this step. In the closed-ended model, the terms and conditions are subsequently transmitted to the customer at step 94. These terms and conditions may include an authorization to make an electronic withdrawal from a checking account belonging to the customer.

If the transaction is approved, then printer (22) or other interactive display device (24) is used to generate a financial instrument (70) at step 111 for execution by the customer, which takes place at step 112. Thus, at step 113, the financial instrument is complete. Accordingly, the merchant system (MS) and the server system (SS) complete a legally binding stand-alone credit instrument initiated by the customer, with the only input having been the customer's identifier and the transaction amount. The sales transaction is thus processed at this step.

On the financial instrument, the customer is provided with a payment date, which in one embodiment, such as in the open-ended model, is calculated at the time of the transaction, as shown in step 114.

Turning to FIG. 2B, in step 115, the maturity date of the payment is batched downloaded and sent at step 116 to the customer's bank for retrieval of funds, in the case of electronic funds transfer (EFT) and automated check clearinghouse (ACH) transactions. If funds are received, then steps 117, 118, and 119 are pursued. In the closed-ended model, since the customer and merchant or provider of credit had no existing agreement at the initial use of the card, the preloaded spending limit may be replenished at step 201 upon a successful completion of payment. Further, where a predetermined number of payment cycles have been completed successfully, the provider of credit may elect to increase the preloaded spending limit at step 202.

If funds are declined, as shown in step 120, then step 121 occurs to lower the credit limit of the customer's account, and a first default letter is sent to the customer in step 122. If the funds are denied due to a closed account 123, then such information is downloaded and sent for collections purposes at step 124, as indicated in step 123. Similarly, if funds were denied because a customer is denied approval at step 125, then such information would be transferred for collections 124.

If the funds were denied for non-sufficient funds (NSF), as shown in step 126, then on the customer's next payday or other pre-selected date at step 127, a second attempt will be made for retrieval of the funds, as shown in step 128. If funds are available, then steps 129, 130, and 131 are followed, with the customer's account being balanced.

If funds are again denied at step 132, then a second default letter is sent to the customer at step 133, and if the funds are denied for non-sufficient funds at step 134, because the customer is denied approval at step 135, or because the customer's account was closed at step 136, then such information is transferred for collections at step 137.

From the foregoing, it can be seen that a merchant, or its designee, and a customer completes an application or customer note, such as element 70 shown in FIG. 3 for either an open-ended or closed-ended line of credit. The customer may also indicate a payment mechanism to be used. Such payment mechanism can include by way of non-limiting example, payment by check, by cash, or by electronic funds transfer (EFT) or automated check clearinghouse (ACH). After completing the application, the customer, as an incentive, may be given an instant credit good for an agreed amount of credit for merchandise.

At the point of sale, the customer executes a financial instrument, such as an open-ended or closed-ended credit or loan agreement, which has been generated by the merchant system (MS) and server system (SS). The financial instrument is preferably in compliance with applicable laws and regulations, and its generation is begun as follows:

The customer presents, and the merchant receives, the card, which has been issued by the merchant or the merchant's designee. The card includes information stored on a magnetic strip, such as an account number associated with the card. The merchant at the point of sale ascertains the information by, in the case of a card, swiping the card over a reader, or simply by manual input of the card number, customer's name, or other identifying method.

The customer, requesting to use the card, may in some embodiments give other information as well. The other information may include a check having disposed therein account indicia. Further the customer may give, and the merchant may receive, at least one piece of identification information from the customer. In one embodiment, the identification information includes a driver's license number.

The merchant uses a merchant system (MS) to transmit information concerning the customer and the amount of the transaction to the server system (SS), which may be located at the merchant's location, or at an off-site location. The databases within the server system (SS) then process the request. In the open-ended model, this processing includes approving or disapproving an additional transaction on a revolving credit line. In the closed-ended model, this includes activating the card for a closed-ended, single installment, installment transaction.

Where required, the databases in the server system may include the following information: the name of customer; the social security number of customer; the payment plan for customer; the date the payment plan indicates payment will be made; the credit limit for the customer; the amount of credit available; the current amount owed by customer; other information required by individual states or jurisdictions for completion of financial documents; and miscellaneous information that may be required by the merchant or a government regulatory body.

The server engine is programmed with software that takes the information from the point of sale at the merchant's location and performs the following functions: determines and calculates necessary federal and state “truth in lending” disclosure information including finance charges, amount financed, transaction fee, total payments, payment schedule, and an annual percentage rate of interest, if necessary. The software can, if necessary, calculate variable annual percentage rates, based on the date of the transaction and the date of payment, which may vary from financial instrument to financial instrument, and transaction to transaction; determines the payment schedule for the payment plan agreed to in the contract; determines the actual date or dates of payments to be made by the customer and the method of payment; formats the financial instrument using the information computed above for signature by the customer at the point of sale; and communicates with the point of sale terminal (which may be a separate terminal for these transactions or any printer capable of printing the contract, or display capable of displaying an electronic form of the contract, or the cash register, preloaded phone card terminals, or other terminals or stations).

The result of the foregoing is thus a legal, stand-alone financial instrument, one possible example being shown as element 71 in FIG. 4 for the closed-ended model (ready for the customer signature at the point of sale, for the amount of the transaction, or combination of transactions). In the open-ended model, this financial agreement comprises agreement to an additional transaction in a revolving credit agreement. In the closed-ended model, this agreement is a closed-ended, single installment, installment loan agreement. In the closed ended model, the customer may be granted instant credit, before even having his information verified or checked.

One feature of the present invention is that the customer initiates the system. The customer, by requesting the use of a card, and presenting such at the point of sale, initiates the process, which ultimately results in the generation of uniquely tailored financial instruments. These financial instruments are developed, as discussed above, through accessing of data from specified databases, within a server system, and by manipulation of such data.

While the present invention has been discussed in terms of a customer and merchant relationship, it is to be understood that the present invention could be easily adapted and used between businesses, in so-called “B to B” relationships. It is to be further understood that the present invention contemplates production of financial instruments, which could be either negotiable or non-negotiable instruments. While the financial instruments discussed here have been referred to in certain instances as loans or credit documents, they could also be advances, deferred payment documents, layaway documents, etc.

Embodiments of the present invention calculate, format, and print Truth in Lending information and the appropriate transaction fee at the point of sale and, in one preferred embodiment, provides a date certain in which payment will be drafted from the customer's account through an electronic funds transfer.

Accordingly, the present invention involves a method of offering point of sale credit and making a point of sale transaction, in a closed-ended context, comprising: providing a financial card at a point of sale; receiving a request for use of the financial card at the point of sale from a customer; receiving a check having disposed thereon account indicia from the customer; receiving at least one piece of identification information from the customer; transmitting a financial card identifier and the at least one piece of identification information to a provider of credit; and processing a sale transaction using the financial card for payment. An activation acknowledgement may then be provided from the provider of credit, at which time a closed end, single installment, installment loan agreement is delivered to the customer.

In one embodiment, the financial card is a preloaded credit card. The preloaded credit card may have an associated preloaded spending limit, such as twenty-five dollars.

As viewed from the provider of credit, the method includes the following steps: providing at least one financial card having a financial card account number associated therewith to a point of sale merchant; receiving from the point of sale merchant at least the financial card account number and at least one piece of identification information from the point of sale merchant in response to a customer desiring to use the at least one financial card; activating the at least one financial card; and transmitting an authorization acknowledgement to the point of sale merchant.

In the closed-ended model, the provider of credit may transmit terms and conditions associated with the at least one financial card to the customer after the customer has used the card, thereby assuming financial risks associated with non-repayment. These terms and conditions may include an authorization to make an electronic withdrawal from a checking account belonging to the customer. Where repayment, perhaps by way of an electronic withdrawal from the checking account, occurs successfully, the provider of credit may either replenish or extend the preloaded credit limit.

In an open-ended model, the method includes the steps of providing at least one financial card having a financial card account number associated therewith to a point of sale merchant;

receiving from the point of sale merchant at least the financial card account number and at least one piece of identification information from the point of sale merchant in response to a customer desiring to use the at least one financial card; activating the at least one financial card; transmitting an open-ended installment loan agreement, which may be printed at the point of sale for signing by the customer. The agreement may include an additional authorization to make a plurality of electronic withdrawals from a checking account belonging to the customer.

The present invention further involves a method of making a point of sale transaction comprising: under control of a merchant system, in response to a customer providing customer identifying information, sending a request to authorize the customer's purchase of an item, along with an identifier of the purchaser of the item to a server system; under control of an authorization component of the server system, receiving the request, sending an inquiry to an account verification facility having stored information relating to the customer, generating an authorization to purchase the requested item for the customer identified by the customer identifier information in the received request and upon receiving a purchase authorization from the account verification facility, generating a financial instrument and applying a transaction fee in order to complete the purchase of the item, whereby the financial instrument includes substantially complete Truth in Lending information for the transaction and a date certain in which full payment will be made by the customer; and under control of the account verification facility, upon receipt of the inquiry from the server, querying the stored additional information relating to the customer identified by the customer identifier information in the request, and sending to the merchant system a credit authorization.

The present invention also includes a system for processing orders, comprising: a merchant terminal having a user interface that is interactive to communicate with entities via the internet, the merchant terminal having an input device capable of sending an indication of the amount of an item being purchased, together with an identifier of the customer, upon presentation by the customer of identifier information unique to the customer; a server configured for receiving the purchase information and customer identifier information from the merchant terminal, receiving additional information previously stored for the customer identified by the customer identifier information in the received request; and generating an authorization allowing purchase of the requested item for the customer identified by the customer identifier information in the received request using the retrieved additional information; and an account verification facility for receiving the account verification data, comparing the account verification data with stored account data corresponding to the customer, and generating a transaction approval; and the server being further configured to receive the transaction approval generated by the account verification and for applying a transaction fee and for generating financial instruments containing substantially complete Truth in Lending information regarding the transaction and a date certain in which full payment will be made by the customer.

In one embodiment of this open-end/revolving credit arrangement, a store could take an ID card, driver's license, military identification, PIN number, and/or other identifier of a consumer having such an open-end/revolving credit account, and deliver cash to the consumer after processing the consumer's loan request through a terminal, such as computer (28). The transaction could be performed wherein the consumer receives a printed statement at the time credit is obtained from his or her open-end/revolving credit account, or, alternately, the system could be paperless, and instead provide the consumer with a statement which is emailed to an email account designated by the consumer or simply displayed on the screen, with the consumer choosing not to receive a printed statement.

The present invention contemplates a further alternate embodiment including using the server system equipment for both merchant credit sales and for providing a cash loan to a customer, using the same or a modified database. In such an arrangement, a customer could approach an automated checkout stand, a checkout stand attended by an attendant, an ATM, a kiosk 72, etc., and enter an icon on a display screen, or take some other action, such as entering a PIN, swiping an identification card, driver's license, smart card, or other similar device, and indicate he or she wishes to take out a loan. Such server system equipment would query the amount of money requested by the customer and would process such a loan in a manner as discussed above on a closed end credit arrangement or an open-end/revolving credit arrangement. The printer (22) can be used to print a completed loan document ready for the customer's signature, or, as discussed above, alternately, the customer may sign a keypad having their signature recorded electronically. The customer could elect whether to receive or not receive a printed statement. If a printed statement is delivered and signed by the consumer, then the consumer would either deposit the statement in a specified location with respect to the equipment, or, if the station is attended, provide the signed copy of the loan document to the attendant. After confirmation that the consumer has provided a signature, either electronically or on paper, the cash requested by the consumer would be provided, to the extent that provision of such cash could not exceed the consumer's available credit.

Another alternate embodiment of the present invention could be a modification of the merchant system (MS) and server system (SS) discussed above such that a signature-based electronic check (E-check) could be used. In this embodiment, the server system SS would be configured to immediately poll the user's bank account on which the E-check is drawn, and if the funds are available, immediately removes such funds specified in the E-check from the account. In the event the funds specified in the E-check are not available, to the extent there is a deficiency, the server system SS would generate either a closed end loan document, which would be deducted from the consumer's account after the consumer's next payday, or other specified date, or, alternately, generate a loan from an open-end/revolving credit loan account which had already been put in place by the consumer, and generate the necessary statement, as discussed above, for the consumer.

Furthermore, it should be understood that the systems of the present invention could be configured to accept as suitable identification a user's personal check for ID purposes. If the user/consumer had already established a merchant credit and/or open-end/revolving credit account, such account would already be tied to the consumer's bank account reflected on the check, the consumer would then only need to provide, perhaps, a PIN, driver's license, military ID, or other suitable identification.

It is to be further understood that the open-end/revolving credit arrangements discussed above could work either separately, or in conjunction with the merchant credit system in order to automatically debit a consumer's account to EFT or ACH upon the user's next payday, or at some other predetermined date.

A still further version of the present invention includes the use of a customer's check, and the presentation by the customer of the check in order to form a credit agreement. Using only a check written or otherwise presented to a merchant and/or a debit card, the merchant can create a closed-end merchant consumer credit sale and/or an open-end/revolving credit arrangement that is in compliance with applicable federal, state, and local law and regulations.

To illustrate this version of the present invention, the customer chooses the merchant's goods or services the customer wishes to purchase. When asked for payment, the customer selects an option on a keypad, touch screen, or interface which may be identified as “Bill Me Later,” or by some other suitable designation. Alternately, the customer simply informs the merchant that they would like the transaction to be a credit one. A blank check from the customer's financial institution's account is scanned, and using the information printed on the check itself (or using information from a debit and/or an ATM card of the customer), the customer's information associated with such account (such as name, address, phone number, financial institution account number, etc.) is received and used by the server system (SS) to generate a consumer credit note which is printed at the register, kiosk, self-serve check-out, point of sale location, or some other location. Alternately, such consumer credit note could be mailed or emailed to the customer if desired. This consumer credit note would preferably include the name of the customer, the terms of the note, the Truth in Lending information and the method of payment. The information necessary to form the consumer credit note is thus generally available and derived from scanning the customer's check. If desired, the customer could also be required to enter his or her PIN at the time of the transaction, for added security.

A third party may administer this version of the present invention using the customer's financial institution account number and databases discussed above in regards to generation of the actual loan or credit documents. The initial presentation of the check would be the functional equivalent of the application process discussed above, with the exception that in such a version of the present invention, a check is given instead of requiring the prior execution of a credit agreement. It should also be appreciated that the presentation of the check could be in addition to a credit agreement. In such an embodiment, the check could be signed or otherwise executed by the consumer (for example, through use of a password and PIN, etc.). In this version of the present invention, a third party would be able to track and manage the credit given or offered to the customer based on the customer's financial institution account information alone. The financial institution could, if desired, actually image the check and maintain such image of the check for information and potential collection action purposes. The third party could also charge the customer a fee for generating the credit documents, which would be added to the amount of the customer's transaction. Alternately, the merchant may absorb the cost of any such third party fees as an accommodation to the customer.

In its simplest form, this version of the present invention would not require the customer to have at some earlier time signed or executed a credit application. The credit would be given to the customer solely based on the customer's check, and if the check would normally be accepted under typical check acceptance rules or guidelines, then the credit agreement would be generated simply by the customer's presentation of the check. This system could be potentially attractive to a merchant for a customer who does not regularly shop at that particular merchant, such customer being less likely, perhaps, to sign up for the merchant's formal, credit program. The merchant would thus be able to extend credit to the customer, based on the acceptance of the customer's check, with the databases discussed above being used to generate the Truth in Lending information and other information and also to generate the necessary credit documents for printing, mailing, emailing, etc. to the customer. In these cases, the merchant would potentially reduce the overhead associated with such a one-time or infrequent customer by simply accepting the check as a basis for extending credit, rather that generating, processing, and retaining a separate agreement, issuing the customer a card, etc.

As to the payment of such credit extended under this version of the present invention, the merchant would provide for a specified time period after which the merchant would debit (through ACH, EFT, etc.) the customer's financial institution account. This time period can be a matter of days, weeks, months, etc., depending on the merchant, customer, goods or services purchased, value of the credit, or other factors. A set fee could be charged by the merchant for the transaction, and the amount of such fee could be based on the amount of credit extended and/or the length of time that the merchant waits before debiting the customer's account. As noted above, in addition to the consumer being required to present a check, the merchant could also require other forms of personal identification, such as a driver's license, PIN, or other means of identification.

Alternately, or in addition to the statements discussed above generated incident to the point of sale, statements of the customer's open-end/revolving account credit arrangement could be mailed and/or emailed and/or voice-mailed (using live human and/or computer generated messages) to the customer on a non-periodic basis or on a periodic basis, such as monthly, bi-monthly, quarterly, etc. These statements would preferably be in compliance with all federal, state, and local laws and regulations relating to open-end/revolving credit accounts and would reflect any debits to the customer's account during the period of time covered by the statement. The statements would also reflect any payments or credits made to the customer's account during the statement period. Such payments could include payments made by check, cash, electronic check (E-check), debit card, credit card, ATM card, account transfers, PayPal ®, or other payment methods, and would also preferably include payments made from any specific or automatic debiting of the customer's account through EFT or ACH upon the customer's paydays, or on other predetermined dates.

In another embodiment of the present invention, an open-end/revolving account credit arrangement may be established by the customer with a merchant by having an open, valid bank account, such as a checking, savings, money market, etc. account. No credit check would be necessary, and a credit line could be established on a real-time (or near real-time) basis, provided the customer could establish such a bank account, through presentation of a blank check, debit/ATM card, credit card, proof of a savings account, etc.

Upon opening of the open-end/revolving account credit account, a calculation could be made at the time of each customer transaction and printed on the statement and/or receipt. Such a customer transaction could be when merchandise or a service is purchased, a cash loan is made to the customer, etc. The statement could preferably include information as to when the customer's bank account will be debited by EFT, ACH, debit card, credit line, etc. (and the specific account which will be debited). Based on the number of days between the customer transaction and the account debit date, an interest charge could be calculated and printed on the statement (which could be paper, an electronic equivalent, an email, etc.) received by the customer at the time of the transaction.

In addition to, or in lieu of, the calculated interest charge, a transaction charge could be applied to the customer's transaction, and such transaction charge would then appear on the statement. Preferably, such a transaction charge is converted to an annual percentage rate (APR) equivalent, per Truth-in-Lending (TIL) requirements and reflected as such on the statement. Depending on the arrangement between the customer and the merchant, the entire outstanding balance on the account could be paid at the time the customer's account is debited, or some lesser amount, such that a balance on the account is carried forward.

In addition to, of instead of, the customer providing a valid, open bank account, the customer could provide another credit line or credit card account to be associated with the establishment of the open-end/revolving account, and such credit line or credit card account ( collectively referred to herein as a “credit card”) could then be charged instead of, or in combination with, using an EFT, ACH or debit card debit of the customer's bank account. In essence, this arrangement could be a first open-end/revolving credit account of the present invention that is funded by a second open-end/revolving credit account or credit card. For example, the customer could provide the merchant or other credit issuer with a valid credit card, debit card, or ATM card and the information necessary to establish the open-end/revolving account could be derived from such card.

There may be occasions when having the first open-end/revolving credit card (or other credit account) based on a credit account is advantageous. For example, if an initial transaction made on the open-end/revolving credit account (discussed above) is treated as a merchandise purchase, then the customer may receive a benefit by charging that transaction and having it paid by a credit card, if the credit card provides incentives, such as bonus points, frequent flyer miles, cash back incentives, discounts, etc. for merchandise purchases. This benefit could be increased if both the open-end/revolving credit account and the credit card provide incentives for merchandise purchases.

Also, there may be occasions where a customer does not have a bank account, but does have a credit card account. In those instances, the customer could still potentially establish an open-end/revolving credit account contemplated by the present invention through presentation of the credit card to the merchant and through the merchant's extraction of information from the credit card.

Further, there may be instances where the customer does not wish for the credit card to be used for the initial transaction. Statements as noted above could be issued on a periodic or non-periodic basis reflecting the charges and credits during the statement period and also the date when the next charge will be placed on the credit card provided by the customer, together with the other information disclosed above as required by law and/or regulation. In the foregoing specification, specific embodiments of the present invention have been described. However, one of ordinary skill in the art appreciates that various modifications and changes can be made without departing from the scope of the present invention as set forth in the claims below. Thus, while embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. A method for providing point of sale credit, the method comprising the steps of;
a. providing a financial card at a point of sale;
b. receiving a request for use of the financial card at the point of sale from a customer;
c. receiving a check having disposed thereon account indicia from the customer;
d. receiving at least one piece of identification information from the customer;
e. transmitting a financial card identifier and the at least one piece of identification information to a provider of credit; and
f. processing a sale transaction using the financial card for payment.

2. The method of claim 1, further comprising the steps of receiving an activation acknowledgement from the provider of credit.

3. The method of claim 2, further comprising the step of delivering a closed-ended, single installment, installment loan agreement to the customer.

4. The method of claim 1, wherein the financial card comprises a preloaded card.

5. The method of claim 4, wherein the preloaded card has associated therewith a preloaded spending limit.

6. The method of claim 5, wherein the preloaded spending limit is less than fifty dollars.

7. The method of claim 6, wherein the preloaded spending limit is twenty dollars.

8. The method of claim 1, wherein the identification information comprises a drivers license number.

9. The method of claim 1, wherein the check comprises a blank, voided check.

10. The method of claim 9, wherein the account indicia comprises a checking account number.

11. A method of providing point of sale credit, the method comprising the steps of:
a. providing at least one financial card having a financial card account number associated therewith to a point of sale merchant;
b. receiving from the point of sale merchant at least the financial card account number and at least one piece of identification information from the point of sale merchant in response to a customer desiring to use the at least one financial card;
c. activating the at least one financial card; and
d. transmitting an authorization acknowledgement to the point of sale merchant.

12. The method of claim 11, further comprising the step of transmitting terms and conditions associated with the at least one financial card to the customer.

13. The method of claim 12, wherein the terms and conditions comprise an authorization to make an electronic withdrawal from a checking account belonging to the customer.

14. The method of claim 13, further comprising the step of making the electronic withdrawal from the checking account.

15. The method of claim 14, wherein the financial card comprises a preloaded credit card, further comprising the step of replenishing a predetermined spending amount associated with the preloaded credit card.

16. The method of claim 15, further comprising the step of increasing the predetermined spending amount based upon a payment history and a completed payment of a current obligation.

17. The method of claim 11, further comprising the step of delivering a closed end, single installment, installment loan agreement.

18. A method of providing open-ended point of sale credit, the method comprising the steps of:
a. providing at least one financial card having a financial card account number associated therewith to a point of sale merchant;
b. receiving from the point of sale merchant at least the financial card account number and at least one piece of identification information from the point of sale merchant in response to a customer desiring to use the at least one financial card;
c. activating the at least one financial card;
d. transmitting an open-ended installment loan agreement.

19. The method of claim 18, wherein the open-ended installment loan agreement comprises an authorization to make a plurality of electronic withdrawals from a checking account belonging to the customer.

20. The method of claim 18, wherein the open-ended installment loan agreement includes an amount of available credit.

21. The method of claim 18, wherein the open-ended installment loan agreement includes a listing of all transactions to be paid by a predetermined due date.

22. The method of claim 18, wherein the open-ended installment loan agreement includes a listing of an item selected from the group consisting of a name of the customer, a social security number of the customer, a payment plan for the customer, a date a payment plan indicates a payment will be made, a credit limit of the customer, a current amount owed by the customer, and information required by a governmental regulatory body.

23. A method of making a point of sale transaction, comprising:
a. under control of a merchant system, in response to a customer providing customer identifying information, sending a request to authorize a customer's purchase of an item, along with an identifier of the item to a server system;
b. under control of an authorization component of the server system, receiving the request, sending an inquiry to an account verification facility having stored information relating to the customer, generating an authorization to purchase the requested item for the customer identified by customer identifier information in a received request and upon receiving a purchase authorization from the account verification facility, generating a financial instrument and applying a transaction fee in order to complete the purchase of the item, whereby the financial instrument includes substantially complete Truth in Lending information for the point of sale transaction and a date certain in which full payment will be made by the customer; and
c. under control of the account verification facility, upon receipt of the inquiry from the server system, querying the additional information relating to the customer identified by the customer identifier information in the request, and sending to the merchant system a credit authorization.

24. A system for processing orders, comprising:
a. a merchant terminal having a user interface that is interactive to communicate with entities via the internet, the merchant terminal having an input device capable of sending an indication of an amount of an item being purchased, together with an identifier of a customer, upon presentation by the customer of customer identifier information;
b. a server configured for receiving purchase information and customer identifier information from the merchant terminal, receiving additional information previously stored for the customer identified by the customer identifier information in a received request; and generating an authorization allowing purchase of the requested item for the customer identified by the customer identifier information in the received request using the additional information; and an account verification facility for receiving account verification data, comparing the account verification data with stored account data corresponding to the customer, and generating a transaction approval; and
c. the server being further configured to receive the transaction approval generated by the server and for applying a transaction fee and for generating financial instruments containing substantially complete Truth in Lending information regarding the order and a date certain in which full payment will be made by the customer.
